(19) United States
(12) Patent Application Publication
(10) Pub. No.: US 2024/0278456 A1
(43) Pub. Date: Aug. 22, 2024

(54) Method for producing fire retardant, decay resistant lumber, and production line for its implementation

(71) Applicants: Robert Bado, Delray Beach, FL (US); Artem Madatov, North Bethesda, MD (US)

(72) Inventors: Robert Bado, Delray Beach, FL (US); Artem Madatov, North Bethesda, MD (US)

(21) Appl. No.: 18/105,876

(22) Filed: Feb. 5, 2023

(51) Int. Cl. B27K 5/04; B27K 3/08; B27K 3/18

(52) U.S. Cl. CPC B27K 5/04; B27K 3/08; B27K 3/18; B27K 2240/30

(57) ABSTRACT

The invention provides the method for producing fire retardant, decay and moisture resistant lumber, and production line for its implementation, achieved by combining a treatment chamber and other technological components in one production line, resulting in possibility of carrying out a multi-stage lumber treatment within the same treatment chamber, by using water-insoluble natural mineral raw materials to impart refractory, decay and moisture resistant properties to the lumber by impregnation through a two-stage process, consisting of converting the insoluble natural mineral, e.g. magnesite, into the wood impregnating solution, followed by transforming the dissolved mineral inside the wood capillaries into an insoluble heat, decay and moisture resistant material.

### FIELD OF THE INVENTION

The present invention refers to production of fire retardant and rot resistant lumber by impregnation of wood with chemicals inside the vacuum chambers.

### BACKGROUND OF THE INVENTION

Wood is the most popular and widely used construction material. Wood is inexpensive and convenient building material. Millions of power line poles, sleepers and piles in low-rise construction are installed every year around the world. However, wood is flammable and susceptible to rotting.

Meeting building fire codes, especially for buildings in high-density areas, is one of the most crucial steps in completing the building construction process. To improve overall building safety and ensuring building codes are being met, contractors are increasing their use of fire retardant wood for projects.

To prevent rotting, impregnation of wood with antiseptics and chemicals is used.

Water-borne copper-chromium-arsenic (CCA) wood preservatives, usually based on a mixture of copper sulfate, sodium or potassium dichromate, and arsenic pentoxide, have been commercially available for many years. Pressure impregnation methods are commonly used to treat wood and fix preservatives in it. One of such methods is described in ‘METHOD OF IMPREGNATING WOOD’ Publication Number WO/1983/004212, International Application No. PCT/GB1983/000146. CCA preservatives are effective against white and brown rot-causing basidiomycetes in both hardwood and softwood, which has been well known for a long time in many countries. The main disadvantage of CCA preservatives is their inability to adequately control copper-resistant soft rot fungi that attack a wide range of wood species, especially hardwoods, when exposed to very wet conditions such as ground contact. In addition, CCA components contain chemicals that are expensive and toxic to humans. For this reason, the CCA impregnated wood cannot be used in residential construction.

A more reliable and less harmful antifungal agent for humans is described in the ‘Wood Treatment Process and Solution provided therefore’ US-2006071196-A1. The process includes providing a periodic acid concentrate with at least 3 wt % periodic acid neutralized to a pH of at least 4 with at least one base selected from Sodium hydroxide, potassium hydroxide and ammonium hydroxide. The periodic acid concentrate is diluted to form a treatment periodic acid solution with about 0.01 wt % to about 0.5 wt % periodic acid. Wood is treated with the periodic acid solution.

Unfortunately, materials and methods for obtaining salts of periodic acid are expensive and time-consuming to introduce into mass production. In addition, there is no guarantee that the solution of salts of periodic acid will penetrate into the deep layers of massive lumber and the fungi in the depth of the wood will be neutralized.

Thermal treatment of lumber for its full thickness is guaranteed to destroy fungi. Thus, the impregnation process is often combined with thermal treatment of wood. There are several known methods and chemical compositions for impregnating wood with oils and high-boiling point hydrocarbons at elevated temperatures, for example, ‘METHOD FOR IMPREGNATION OF WOOD COMPONENT WITH SOLID PARAFFIN WAX, APPARATUS THEREFOR AND WOOD COMPONENT SO IMPREGNATED’ U.S. Pat. No. 9,682,493 B2. A method for treating a piece of wood impregnates the piece of wood with a water repellent, wherein the water repellent is solid at ambient temperatures. The method includes the steps of providing a piece of wood to be treated; heating the piece of wood for a predetermined period of time, the piece of wood being heated at a temperature A. Subsequently immersing at least a portion of the piece of wood in a bath of liquefied water repellent, the bath being at a temperature B, for a predetermined period of time. Thereafter the piece of wood is removed from the bath and allowed to cool. The temperature A is above 100° C. and the temperature B is below 100° C. but above a liquefying point for the water repellent, and a differential between temperatures A and B is at least 60° C.

The disadvantage of this and other similar methods is the need to carry out the impregnation process at an elevated temperature, sometimes more than 200° C. At the same time, vapors of oils and hydrocarbons enter the air of the working area, thus worsening the working conditions of personnel and creating favorable conditions for ignition of these vapors. Due to a high viscosity of impregnation liquid, the impregnation process takes many hours. All of the above leads to a high cost and decrease in process productivity. And most importantly, wood impregnated with hydrocarbons or oils becomes even more fire hazardous.

Therefore, it is desirable to impregnate wood with compounds that not only prevent wood decay, but also make it fire resistant.

‘WOOD TREATMENT METHOD AND COMPOSITION’ EP-1392452-A4 describes a composition for making wood both resistant to decay and resistant to fire.

The invention relates to a method for improved wood preservation by synthesizing and using a non-toxic, environmentally friendly aqueous composition with increased efficiency. A process for reducing the rate of deterioration of wood that includes contacting the wood with an aqueous alkaline colloidal silicon-containing slat composition that is supersaturated with a boron-containing salt. The contacting may be at ambient or elevated temperature and pressure. The composition is an aqueous colloidal silicon-containing salt that is supersaturated with a boron-containing salt and optionally includes an aluminum salt and a preservative. The composition is made by mixing the boron-containing salt with a colloidal, aqueous mixture of a silicon-containing salt and optionally adding the aluminum salt and the preservative. The process is performed under conditions that result in a supersaturated solution of the boron-containing salt. Wood treated with the composition appears to be resistant to insects, rot, UV deterioration, fire, and other environmental insults. The wood also appears to have increased strength.

The disadvantages of this technology include high cost of chemicals, complexity of preparing the composition and need for long impregnation process due to a high viscosity of colloidal solutions.

A cheaper wood impregnation compound for turning wood into a fire resistant material is described in ‘Process for preserving wood’ US374296A. It has been established that the ability of water-soluble protective agents introduced into wood to leach can be reduced by impregnating the wood successively with two solutions, which include sparingly soluble compounds, but one solution contains substances that reduce the water solubility of substances contained in another solution. To carry out the invention, for example, wood is first treated with about 2.0% sodium fluorosilicate solution and then impregnated with 4.0% common salt solution. When wood is dried, a mixture of sodium fluorosilicate and table salt remains in it. Now the wood comes into contact with water, table salt, which is highly soluble in water, goes into solution and thereby makes it difficult to leach sparingly soluble compounds from sodium fluoride-silica, since this salt is much more difficult to dissolve in a solution of sodium chloride than in water alone. The precipitate of sodium fluorosilicate that has fallen inside the wood capillaries is no longer washed out by water and ensures the protection of wood from fire. The precipitate of sodium fluorosilicate that has settled inside the wood capillaries is no longer washed out with water and ensures the protection of wood from fire.

The disadvantages of the method include the toxicity and high cost of sodium fluorosilicate, as well as the need to soak the wood twice for a long time in different baths.

An even cheaper and safer impregnating composition is the natural bischofite, magnesium dichloride. The patent RU2469843 ‘Flame retardant composition for wood treatment’ describes a composition based on bischofite.

The invention relates to compositions for protecting wood from fire and decay and can be used in the woodworking industry. The fire retardant composition for wood treatment contains bischofite, water, magnesium acetate, oxalic acid and ferrous hydroxide. pH of the solution is not more than 3.0 units. The density of the composition is within 1120-1140 kg/m3. Penetrating ability, as well as the fire retardant and bioprotective effectiveness of the composition are increased, toxicity and aggressiveness of the composition are reduced.

The disadvantages of the composition include the transition of soluble magnesium dichloride to water-insoluble magnesium oxalate when mixing the components of the composition. As a result, most of the magnesium and oxalic acid precipitate and cannot penetrate into the capillaries of the wood. Also, oxalic acid and magnesium acetate are quite expensive substances.

Therefore, the development of an inexpensive and effective flame retardant composition for wood impregnation is still an essential task.

There is also a problem of increasing the productivity of the wood impregnation process and reducing labor costs. It is known that the main obstacle to the penetration of liquid into the micro-capillaries of wood is the air that occupies those capillaries. The capillary force draws liquid into the capillaries, thus displacing the air from them. However, the magnitude of these forces is negligible and the liquid displaces air very slowly. Much faster, the liquid penetrates into the capillaries under the action of an external pressure force. Therefore, the sequence of technological operations, which is often used to speed up the process of wood impregnation, includes the processing of lumber in special pressurized chambers where the impregnating liquid is under pressure.

‘Device for wood impregnation’ according to the Russian patent RU 2684312 contains a frame, pipelines, a compressor, a high-pressure fuel pump, a vacuum pump, a tank with impregnating solution, a hydraulic cylinder, a 16-cavity press a mold for sealing timber bars, a vacuum receiver to maintain a constant negative pressure of 80 kPa for the entire impregnation cycle. The compressor is configured to create a constant pressure through the overpressure receiver by means of pneumatic valves. The impregnating solution tank is connected through a filter to the high pressure fuel pump. Each cell of the mold is connected to the overpressure receiver through sixteen pneumatic valves. A high-pressure fuel pump and an overpressure receiver, which is pumped up by a compressor, are connected by pipelines to the upper cells of the mold through nozzles. The lower cells of the mold are connected to a vacuum receiver, in which vacuum is created by a vacuum pump. EFFECT: increased productivity of the wood impregnation device.

The disadvantages of the device include low productivity due to manual loading and unloading of lumber.

Therefore, manufacturers prefer wood processing in hermetically sealed chambers, where lumber of various sizes and shapes can be loaded. Acceleration of the process of penetration of the impregnating solution into the wood capillaries can be achieved by increasing the pressure of the impregnating liquid.

Apparatuses and production lines for wood impregnation using pressure difference have been developed.

Such method of impregnation of wood under pressure is described in the U.S. Pat. No. 4,086,056A ‘Process for impregnation of timber’. A process of impregnating one or more timber articles, such as timber doors, with a treatment agent in which the articles are placed in a treatment chamber which is then filled with the treatment agent. The treatment agent is then pressurized, preferably by pumping more treatment agent into the chamber, to force the treatment agent into the articles. This pressurizing step is performed quickly, for example, within between 5 and 25 seconds, and the articles are then removed from the chamber.

The disadvantages of the method include insufficient penetration of the impregnating solution deep into the lumber due to the air remaining in the wood capillaries.

Therefore, for fast and complete impregnation of wood, it is necessary to remove air from the wood capillaries with a vacuum pump. When vacuumizing, air leaves the wood capillaries, and when the impregnating solution and air are supplied, the pressure difference forces the solution into the capillaries.

Such method is described in patent EP-1452286-B1 ‘Method for producing non-combustible wood’. By providing a method for producing non-combustible wood that can improve the impregnated amount of non-combustibles in wood as much as possible, and furthermore, as a building standard method, the non-combustible wood that can be produced relatively simply and can be produced relatively simply as a building standard method. To provide a manufacturing method. A drying step of drying the wood (for example, plate B), a depressurizing step of depressurizing the wood, a depressurizing impregnation step of impregnating the fire retardant in the wood under reduced pressure, and a pressure impregnation of the fire retardant impregnating the wood in the pressurized state. A method for producing a non-combustible wood comprising a plurality of steps, each of which comprises a depressurization step, a depressurization impregnation step, and a pressure impregnation step twice, and a drying step three times.

After impregnating wood with a water-based solution, it is important to ensure that the wood is dried to an air-dry state, i.e. up to 6-10% moisture content. To do this, it is best to heat the wood and evaporate the water. For example, resonant microwaves can be used as described in WO1999018401A1. According to the invention, wood is dielectrically heated in a vacuum chamber by a high frequency field which penetrates said wood. The vacuum chamber and all of the parts located in said chamber are kept at a higher temperature than that of the wood. Once the atmosphere in the vacuum chamber is saturated with water vapor, said water vapor is condensed in a separate evacuated condensation chamber. The inventive device for carrying out this method has a vacuum chamber wherein electrodes are arranged for applying a high frequency electrical field to the wood to be dried. A heating system is allocated to the wall of the vacuum chamber. A condensation chamber is also provided, said condensation chamber being connected to the vacuum chamber by a line which can be blocked off by a valve.

The disadvantage of this method is the complexity of the technology (the presence of a high-power microwave generator), high cost (all heat is obtained using electrical energy), danger to personnel (high-frequency electromagnetic fields of high intensity).

It is worth noting, all woodworking enterprises generate a huge amount of wood waste. It is economically feasible to use the heat from the incineration of excess off-grade waste to heat and dry the impregnated wood. To do this, the easiest way is to use hot air in a heat exchanger-superheater, which is heated by burning wood waste.

Such method and a device for its implementation are described in RU2400684C1 ‘Wood drying method and device for its implementation’ using thermal vacuum pulse exposure. The drying method consists of repeated alternation of cycles of blowing wood with a heated air at atmospheric pressure by warming it up to an average volume temperature of 80-100° C., pulsed high-speed evacuation at an operating pressure of not more than 50 mm Hg. for up to 10 seconds with squeezing free moisture without a phase transition of water into steam to a steady-state constant value of the temperature of wood, depressurization to atmospheric pressure by supplying heated air, and purging wood and depressurizing is carried out with heated air with a temperature of 150-300° C. at excess pressure not higher than 0.07 MPa. The installation that implements this method of wood drying includes two drying chambers connected by pipelines with quick-acting valves with a cooled receiver connected in series with the second receiver and with a vacuum pump using a pipeline with a vacuum lock. The first receiver is equipped with helical guides for the flow of the vapor-droplet medium tangentially to the inner diameter of the receiver body. The drying chambers are connected to the heat carrier preparation and supply system. The method and device intensify the drying process and improve the quality.

The disadvantages of the method include the low heat capacity of air and the technical complexity of supplying hot air from the furnace heat exchanger to the chamber.

The present inventors believe that the use of air at 300° C. creates a fire hazard, and it is technically simpler, safer and more energy efficient to use superheated (dry) steam instead of hot air. Superheated steam can be generated in a steam boiler with a superheater using energy from wood waste combustion.

The method of drying wood with steam is described in the patent CN1313178A “Steam technology for drying wood”. An integrated steam drying technology for wood includes such steps as loading wood in kiln, preheating while raising temp at 15 deg. C./hr, ordinary-pressure over-heat steam drying, conventional drying, holding the temp for a certain time, and discharging. Its advantages include high speed and quality, stable size and saving energy.

### SUMMARY OF THE PRESENT INVENTION

The invention provides the method for producing fire retardant, decay and moisture resistant lumber, and production line for its implementation, achieved by combining a treatment chamber and other technological components in one production line, resulting in possibility of carrying out a multi-stage lumber treatment within the same treatment chamber, by using water-insoluble natural mineral raw materials to impart refractory, decay and moisture resistant properties to the lumber by impregnation through a two-stage process, consisting of converting the insoluble natural mineral, e.g. magnesite, into the wood impregnating solution, followed by transforming the dissolved mineral inside the wood capillaries into an insoluble heat, decay and moisture resistant material.

The method consists of removal of water and air from the capillaries of untreated wood heated to 80-90° C. in vacuum; filling the emptied wood capillaries with an aqueous solution of magnesium dichloride under high pressure; transformation of magnesium dichloride into magnesium hydroxide inside wood capillaries when the wood is heated to 300° C.; removal of resulting hydrogen chloride and excess moisture from the wood by drying it with superheated steam.

An important role in the technological process proposed by the present inventors is played by a side process: the circulation of chlorides, which makes it possible to close the entire technological sequence in a cycle, and recycle the by-product, hydrogen chloride. The capture and further use of volatile hydrogen chloride allows, on the one hand, to avoid the formation of harmful emissions (waste), on the other hand, it saves hydrochloric acid and reduces the cost of producing a magnesium chloride solution. Consequently, the recycling of hydrogen chloride is that additional feature that allows the inventors to get a qualitatively new effect: the uniform distribution of a solid insoluble mineral in the full thickness of the wood.

### BRIEF DESCRIPTION OF THE DRAWINGS

FIG. 1 is a schematic representation of the production line for converting untreated wood into a fire retardant, decay and moisture resistant material.

FIG. 2 is a schematic representation of the lumber loading into, its treatment inside and unloading from the treatment chamber.

### DETAILED DESCRIPTION OF THE PRESENT INVENTION

The invention provides the method for producing fire retardant, decay resistant lumber, and production line for its implementation.

The present inventors believe that the use of superheated water steam completely eliminates the possibility of ignition of wood inside a treatment chamber. Steam has sufficient heat capacity to transfer heat into the chamber, it is convenient to produce steam in a standard boiler and supply it through a heat-insulated pipeline over a considerable distance, if needed. An additional useful feature that creates a qualitatively new effect is the use of steam as a chemical reagent for the chemical reaction of hydrolysis of magnesium chloride:

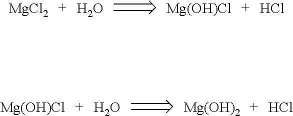

The present inventors target the use of a cheap natural material that would be soluble during the impregnation process and form an insoluble precipitate inside the wood capillaries after a simple treatment.

Such materials are natural magnesium minerals: periclase (magnesium oxide MgO), dolomite (calcium-magnesium carbonate CaCO₃ MgCO₃), brucite (magnesium hydroxide Mg(OH)₂), magnesite (magnesium carbonate MgCO₃).

Like other naturally occurring magnesium minerals, magnesite is insoluble in water. Therefore, the present inventors propose to convert insoluble magnesite (magnesium carbonate MgCO₃) into a soluble magnesium salt (dichloride) by dissolving magnesite in hydrochloric acid:

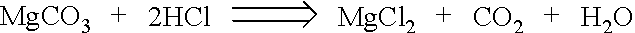

Magnesium dichloride is highly soluble in water (60%) and easily penetrates into the pores of wood. After impregnation, the soluble magnesium salt inside the wood must be converted into an insoluble magnesium compound. To do this, the impregnated wet wood is subjected to heating with superheated steam of up to 300° C. Magnesium dichloride, being a salt of a weak base and a strong acid, is decomposed by water (hydrolysis) by the cation through magnesium oxychloride to magnesium hydroxide:

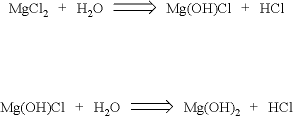

Magnesium oxychloride is the traditional term for several chemical compounds of magnesium, chlorine, oxygen, and hydrogen whose general formula xMgO·yMgCl2·zH2O, for various values of x, y, and z; or, equivalently, Mgx+y(OH)2xCl2y(H2Oz-x).

At ambient temperature, there are also gel-like homogeneous phases that form initially when the reagents are mixed, and eventually crystallize as phase 5, phase 3, or mixtures with Mg(OH)₂ or MgCl₂·6H₂O. (W. F. Cole and T. Demediuk (1955): “X-Ray, thermal, and Dehydration studies on Magnesium oxychlorides”. Australian Journal of Chemistry, volume 8, issue 2, pages 234-251. doi: 10.1071/CH9550234)

There are also other lower hydrates that can be obtained by heating the “natural” phases:

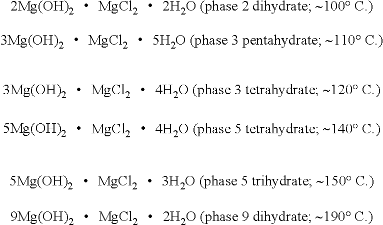

All four stable phases have anhydrous versions, such as 3Mg(OH)₂·MgCl₂ (anhydrous phase 3) and 5Mg(OH)₂·MgCl₂ (anhydrous phase 5), with the crystal structure of Mg(OH)₂, that can be obtained by heating them to about 230° C. (phases 3 and 5) about 320° C. (phase 2), and about 260° C. (phase 9).

Volatile hydrogen chloride evacuates with water vapor. The higher the temperature, the more hydrogen chloride escapes and the more magnesium transitions into the basic oxide.

The kinetics and mechanism of isothermal decomposition of magnesium chloride dihydrate in nitrogen have been studied in the temperature range of 623-803 K https://www.sciencedirect.com/science/article/abs/pii/0040603189872466

The main reaction products were identified as MgO and HCl: the course of the reaction was monitored by titration of the released acid with standard alkali. The stoichiometry is satisfactorily represented by MgCl₂ 2H₂O→MgO+2HCl+H₂O. The influence of the prevailing water vapor pressure, reaction temperature and pre-grinding of the sample was investigated. Using electron microscopy, the textures of partially and completely decomposed salts were examined, confirming that the reaction proceeds in the solid state. Kinetic observations were consistent with the area contraction rate equation, from which activation energies were found to be 110±5 KJ mol-1 in dry nitrogen and 75±7 KJ mol-1 in 10 Torr water vapor.

At temperatures above 500° C., Mg(OH)₂ decomposes with the release of water and only magnesium oxide MgO remains.

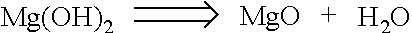

This property of magnesium hydroxide to give off chemically bound water at high temperatures makes the impregnated wood resistant to fire.

However, it is technically difficult and energy wise impractical to heat wood above 300° C.

At a temperature of 300° C., about 90% of hydrogen chloride is released, 10% of the chloride remains in the wood capillaries as insoluble magnesium oxychloride.

The present inventors propose to capture the hydrogen chloride evacuating with water vapor and condense it as hydrochloric acid. Hydrochloric acid can then be used again to dissolve magnesite:

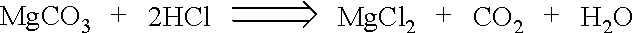

To obtain a required amount of magnesium chloride, an adequate amount (about 10%) of fresh concentrated hydrochloric acid must be added to replace the chloride remaining in the wood as oxychloride. The resulting fresh magnesium dichloride can be used again to impregnate yet untreated wood.

Solidified magnesium oxide-oxychloride has been widely used under the name “Sorel cement” or “magnesium cement” as an inexpensive mineral binder for construction for more than 100 years. Burnt magnesia (MgO) dough is mixed with a concentrated solution of magnesium chloride (MgCl₂) in the cold:

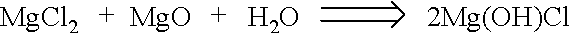

Magnesium oxide-oxychloride exhibits especially good adhesion to wood due to the fact that the magnesium chloride solution easily and quickly penetrates into the pores of the wood. A composite of magnesia cement with sawdust, called “arbolit”, is used for the manufacture of refractory wall blocks and floors in buildings. Sheets of magnesia cement filled with glass fiber can withstand fire with a temperature of up to 800° C.

Thus, the problem of using natural mineral raw materials to impart refractory properties to wood by impregnation was solved by the present inventors through a two-stage process. The first step is to convert the insoluble mineral into the wood impregnating solution. The second stage consists of transformation of the dissolved mineral inside the wood capillaries into an insoluble heat-resistant mineral.

The present inventors propose the following sequence of technological operations for converting untreated wood into a fire retardant, decay and moisture resistant material:
1. Untreated lumber loaded on a trolley is placed into a stainless steel treatment chamber. The chamber's end lids get sealed;
2. Superheated steam is let into the chamber and the lumber is heated up to 80-90° C.;
3. Air is pumped out of the chamber using a vacuum pump;
4. The chamber is filled up through a pipe and valve with aqueous solution of magnesium dichloride;
5. Air is injected into the chamber at a pressure of 0.2-0.3 MPa;
6. After the impregnation that lasts for about 5 minutes, the excess impregnating solution is drained out through another pipe and valve, the air is being released from the chamber;
7. The lumber in the chamber is heated for about 20 minutes with superheated steam at 300° C. until the lumber is dried, water vapor and hydrogen chloride are evacuated using a fan;
8. Cold air is let into the chamber for about 5 minutes until the wood cools down to 70° C.;
9. The chamber's end lids get unsealed and opened, the trolley with the treated lumber is removed from the chamber;
10. The process repeats for another load of untreated lumber;

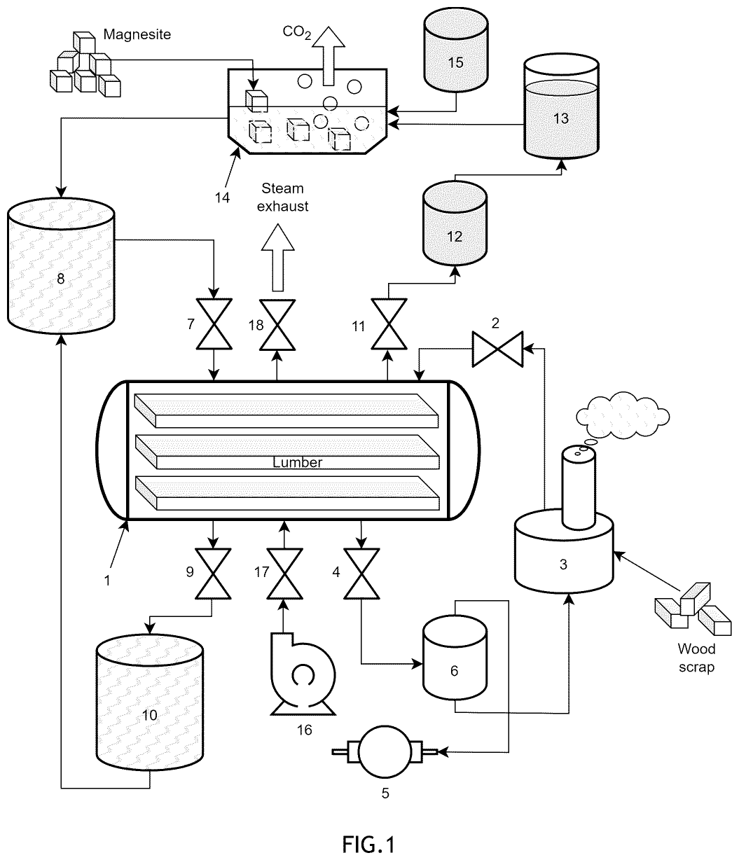

The technological sequence of operations is carried out using a set of equipment schematically shown in the FIG. 1. The production line comprises a treatment chamber (1), a steam valve (2), a steam boiler (3), a vacuum valve (4), a vacuum pump (5), a condenser-separator (6), an impregnating solution inlet valve (7), a tank with impregnating solution (8), an impregnating solution outlet valve (9), a buffer tank (10), a vapor outlet valve (11), a cooler-condenser (12), an acid scrubber (13), a dissolution reactor (14), a hydrochloric acid reservoir (15), an air compressor (16), a compressed air valve (17), an air exhaust valve (18).

Untreated lumber is loaded using a trolley into the chamber 1. The end lids of the chamber get hermetically sealed. The air exhaust valve 18 is to get opened. Steam from the steam boiler 3 through the open steam valve 2 is let into the chamber 1. The lumber is being heated to 80-90° C. The valves 2 and 18 get shut off to stop the steam flow into and through the chamber 1. The vacuum valve 4 gets opened and air is pumped out of the chamber 1 using the vacuum pump 5. The condenser-separator 6 is placed between the vacuum pump and the chamber to remove water from the pumped air. The water condensate is used to feed the steam boiler 3 with water.

At 80-90° C. in vacuum, water and air are removed from the micro-capillaries of the untreated lumber. After vacuumizing, the vacuum valve 4 gets closed, the vacuum pump is turned off. Through the impregnating solution inlet valve 7, the chamber 1 is filled up with a solution of magnesium chloride from the impregnating solution tank 8. After 5 minutes, the valve 7 gets closed, and the compressed air valve 17 gets opened and the pressurized air at 3 atmospheres (0.3 MPa) from the air compressor 16 is pumped into the chamber 1. After 1 to 5 minutes, all the lumber in the chamber becomes impregnated with magnesium chloride. The valve 17 gets closed, and the excess impregnating solution is drained from the chamber 1 through the impregnating solution outlet valve 9 into the buffer tank 10, from which, after filtration, the unused impregnating solution is pumped back into the tank 8, the valve 9 gets closed. The air exhaust valve 18 gets opened so the air is released from the chamber 1 until the air pressure is equalized outside and inside the chamber. Valve 18 gets closed.

The steam valve 2 and the vapor outlet valve 11 get opened. Superheated steam of 350° C. is let into the chamber 1 through the valve 2 to heat up the lumber to 300° C. This process lasts for about 20 minutes, the lumber gets sterilized to its full depth. Simultaneously, magnesium dichloride inside the wood is hydrolyzed by water vapor and turns into magnesium oxychloride and hydroxide:

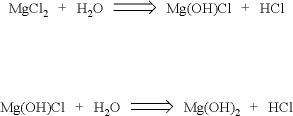

The resulting hydrogen chloride and excess moisture are removed from the treatment chamber in form of vapor through the vapor outlet valve 11 using a fan. Vapors are removed from the chamber along a pressure gradient, cooled and condensed in the cooler-condenser 12. Hydrogen chloride dissolves in water condensate and forms hydrochloric acid. The acid is pumped into the acid scrubber 13 and gets accumulated in there. The air-steam stream from the condenser 12, from which the remaining hydrogen chloride is finally washed out, is being flushed through the acid layer in the scrubber. The remaining air is vented to the atmosphere. Subsequently, the acid from the scrubber 13 is used to dissolve magnesite and prepare a new portion of magnesium chloride solution.

After reaching the temperature of 300° C. in the chamber, valves 2 and 11 get closed, the steam supply is stopped. The supply of cold air to the chamber 1 from the air compressor 16 through the open valve 17 starts. The cooling air is discharged from the chamber to the outside through the open valve 18. After the lumber has cooled to 70° C., the cold air supply is stopped, the valves 17 and 18 get closed.

After making sure the pressure inside the chamber is equal to the pressure outside, the chamber lids get opened and the trolley with the treated lumber is taken out.

To prepare a fresh solution of magnesium chloride, the natural mineral magnesite (magnesium carbonate) is used. The magnesite material crushed into pieces is loaded into an open container (dissolution reactor 14) that is filled with hydrochloric acid from the acid reservoir 15 and the acid scrubber 13. Magnesium chloride forms:

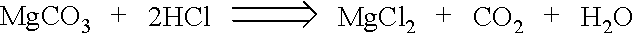

Magnesium chloride accumulates in the impregnating solution, and carbon dioxide surfaces in form of bubbles. Magnesite is added until the gas production stops. Concentration of the magnesium chloride solution must be measured, and should be adjusted to 60% by adding concentrated 37% hydrochloric acid (about 10% by volume) from the reservoir 15 and/or scrubber 13 to the reaction mixture to make up for the loss of chloride due to accumulation of the residual chloride content in the treated wood. At the bottom of the reactor 14, upon the completion of the dissolution process, undissolved magnesite remains. When the release of carbon dioxide bubbles stops, it indicates the end of the reaction after the consumption of the acid in the reaction zone. The produced transparent 60% solution of magnesium chloride, upon settling and sedimentation of turbidity, is pumped into the impregnating solution tank 8.

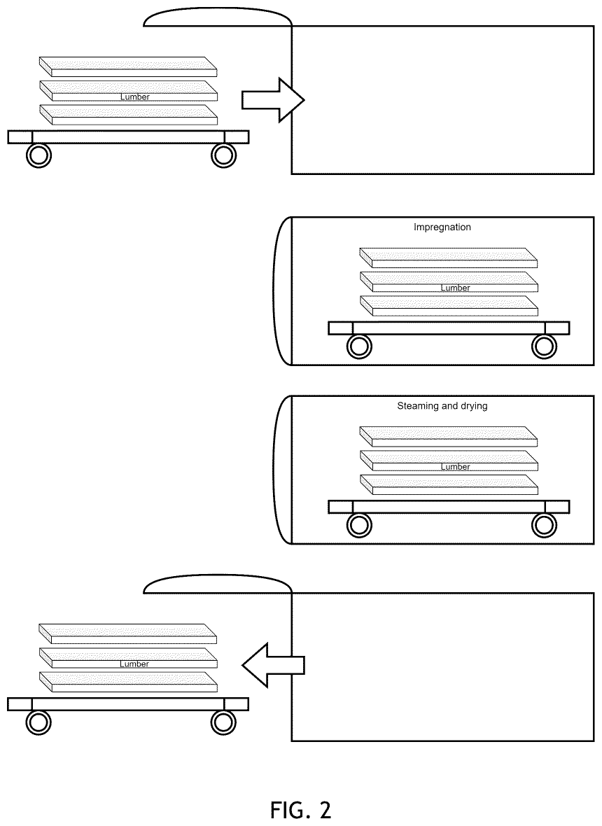

The wood treatment chamber is set to be of a horizontal design and has at least one end lid for the lumber to be loaded and unloaded on a trolley, as schematically shown in the FIG. 2. All of the above described lumber treating operations are carried out inside the same chamber.

Thus, the task of using cheap mineral raw materials to make wood resistant to fire and decay was solved by the present inventors by sequentially treating wood with various agents in the same chamber, connected by pipelines and valves to various devices: a steam generator, a vacuum pump, a tank with impregnating solution, a buffer tank for discharging excess solution, a cooler-condenser with an acid scrubber, an air compressor.

Such combination of the treatment chamber and the devices in one production line led to a qualitatively new result: the possibility of carrying out a multi-stage lumber treatment without reloading wood from one apparatus to another. The use of recycling of a by-product of wood processing, volatile hydrogen chloride, made it possible to use a water-insoluble natural material (magnesite), thus significantly reducing the cost of the impregnating material and solving the problem of by-product disposal.

Impregnation of wood with magnesium hydroxide and magnesium oxychloride significantly increases the fire resistance of wood. As a result of sealing the wood pores with magnesium hydroxide, the treated wood does not absorb moisture and does not swell in water. Processing at high temperature destroys putrefactive fungi and bacteria, and new fungi do not settle in the treated wood.

1. A method for producing fire retardant, decay resistant lumber, including vacuumization of a treatment chamber, impregnation of the lumber placed inside the chamber with a solution of magnesium chloride under pressure, forced drying of the lumber with water steam and air, characterized in that the lumber impregnated with magnesium chloride is subjected to heating with superheated water steam to a temperature of 300° C. to decompose magnesium chloride into magnesium oxychloride and magnesium hydroxide, as well as hydrogen chloride, wherein magnesium hydroxide and magnesium oxychloride remain inside the lumber capillaries, and volatile hydrogen chloride is evacuated from the lumber along with water vapor.

2. The method according to claim 1, characterized in that the volatile hydrogen chloride being evacuated from the lumber together with water vapor is captured, cooled and condensed to obtain hydrochloric acid.

3. The method according to claims 1-2, characterized in that the condensed hydrochloric acid is used to obtain magnesium chloride by dissolving a water-insoluble magnesium mineral, mainly magnesite (magnesium carbonate), brucite (magnesium hydroxide) or periclase (magnesium oxide), wherein the obtained magnesium chloride is used to impregnate new loads of lumber inside the treatment chamber.

4. The method according to claims 1-3, characterized in that the untreated lumber is heated to 80-90° C. before the impregnation with magnesium chloride, followed by vacuumizing the treatment chamber to more completely remove air from the lumber due to displacement of air by the boiling water inside the lumber capillaries.

5. The method according to claims 1-4, characterized in that the lumber heated by the superheated steam is then cooled and dried by cold air to a temperature of 70° C.

6. A production line for implementing the method according to claims 1-5, comprising the treatment chamber hermetically sealable by the end lids, wherein the chamber is connected by pipelines and valves to a steam boiler, a vacuum pump, a tank with impregnating solution, a buffer tank for discharging excess impregnating solution, an air compressor, characterized in that the production line additionally contains a cooler-condenser and an acid scrubber for capturing and condensing hydrochloric acid, as well as a dissolution reactor for dissolving raw magnesium minerals in hydrochloric acid.
